(19) United States
(12) Patent Application Publication
(10) Pub. No.: US 2013/0280203 A1
(43) Pub. Date: Oct. 24, 2013

(54) HIGH STABLE NON-IONIC N-VINYL BUTYROLACTAM IODINE AND PREPARATION METHOD THEREOF

(71) Applicants: Yu Wang, Shanghai (CN); Zhan Chen, Shanghai (CN)

(72) Inventors: Yu Wang, Shanghai (CN); Zhan Chen, Shanghai (CN)

(21) Appl. No.: 13/978,367

(22) PCT Filed: Aug. 18, 2011
(86) PCT No.: PCT/CN2011/078578

§ 371 Date: Jul. 3, 2013

(30) Foreign Application Priority Data
Jan. 7, 2011 (CN) 201110002771.0

(51) Int. Cl. A01N 43/36

(52) U.S. Cl. CPC A01N 43/36
USPC 424/78.3

(57) ABSTRACT

A preparation method of a high-stable non-ionic N-vinyl butyrolactam iodine solution is provided, wherein high-stable non-ionic N-vinyl butyrolactam iodine is dissolved in water, then citric acid, at least one iodine ion stabilizing agent, at least one non-ionic surfactant and at least one emulsifier are added, then the pH is adjusted to 5 with at least one pH adjusting agent, so as to prepare the high-stable non-ionic N-vinyl butyrolactam iodine solution, the high-stable non-ionic N-vinyl butyrolactam iodine is formed by complexing PVP-K30, iodine and at least one grinding aid at a temperature of 60° C.-90° C., the high-stable non-ionic N-vinyl butyrolactam iodine solution prepared by the above mentioned method is also provided, the stability of the high-stable non-ionic N-vinyl butyrolactam iodine solution of the present invention is high.

### FIELD OF TECHNOLOGY

The present invention relates to the technical field of preparing solutions, especially to the technical field of preparing non-ionic N-vinyl butyrolactam iodine solutions, in particular to a high-stable non-ionic N-vinyl butyrolactam iodine solution and preparation method thereof.

### DESCRIPTION OF RELATED ARTS

Non-ionic N-vinyl butyrolactam iodine (PVP-I) is a kind of amorphous powders having yellowish-brown to reddish-brown, an unshaped iodine complex formed by complexing non-ionic N-vinyl butyrolactam (PVP) with iodine, PVP-I for short, and an indophor. PVP-I is an excellent disinfectant, and collected in Chinese Pharmacopoeia of 1990 edition. It can maintain a bactericidal power for a longer time, is a broad-spectrum strong disinfectant, has a relatively strong role in killing viruses, bacteria, fungi and mold spores, and is approved by the Chinese Pharmacopoeia as a sanitizer that can be used directly on human bodies.

For PVP-I is easy to be dissolved in water, has no irritation, allergy and poisoning to skins and mucous membranes, thus it is evaluated very good domestic and abroad. PVP-I not only can be used as an aqueous solution, but also can be used in the solid form in some special occasions. This makes the PVP-I complex be widely used in sterilization, disinfection of various fields, expands the application range of iodine, and makes the PVP-I complex be widely applied in the disinfection of the domestic hospitals. At the present stage, the most widely used solution agent is the PVPI solution in clinic, but the stability of the PVP-I disinfectant produced by traditional methods is not ideal, during storage, due to easy decomposition and sublimation, the content of its available iodine is decreased slightly, and can not meet the quality standard the usage required, and it is more unstable especially in summer, to bring about inconvenience to long-term storage and use of the disinfectant.

Therefore, there is an urgent need to provide a high-stable non-ionic N-vinyl butyrolactam iodine solution, whose stability is high, thereby facilitating long-term storage and use.

### SUMMARY OF THE INVENTION

Aspects of the present invention generally pertain to a high-stable non-ionic N-vinyl butyrolactam iodine solution and preparation method thereof, the stability of the high-stable non-ionic N-vinyl butyrolactam iodine solution is high, thereby facilitating long-term storage and use, thus the high-stable non-ionic N-vinyl butyrolactam iodine solution is suitable for large-scale popularization.

In order to realize the above aims, in a first aspect of the present invention, a preparation method of a high-stable non-ionic N-vinyl butyrolactam iodine solution is provided and characterized in that, high-stable non-ionic N-vinyl butyrolactam iodine meeting a condition that the degradation rate after the high-stable non-ionic N-vinyl butyrolactam iodine is positioned at 85° C. for 15 hours is less than 6.0% is dissolved in water, then citric acid, at least one iodine ion stabilizing agent, at least one non-ionic surfactant and at least one emulsifier are added, then the pH is adjusted to 5 with at least one pH adjusting agent, so as to prepare the high-stable non-ionic N-vinyl butyrolactam iodine solution.

The iodine ion stabilizing agent, the non-ionic surfactant, the emulsifier, the pH adjusting agent and the high-stable non-ionic N-vinyl butyrolactam iodine can be any suitable agents. Preferably, the iodine ion stabilizing agent is potassium iodate, the non-ionic surfactant is Tween 20, the emulsifier is polyethylene glycol 200, and the pH adjusting agent is sodium hydroxide.

The person skilled in the art can add suitable amounts of the high-stable non-ionic N-vinyl butyrolactam iodine, the citric acid, the iodine ion stabilizing agent, the non-ionic surfactant and the emulsifier according to the experience. Preferably, the high-stable non-ionic N-vinyl butyrolactam iodine is 20 g, the citric acid is 0.5-5.0 g, the iodine ion stabilizing agent is 0.1-1.0 g, the non-ionic surfactant is 0.1-1.0 g and the emulsifier is 0.5-5.0 g.

The high-stable non-ionic N-vinyl butyrolactam iodine can be provided in any suitable manner. Preferably, the high-stable non-ionic N-vinyl butyrolactam iodine is formed by complexing PVP-K30, iodine and at least one grinding aid at a temperature of 60° C.-90° C. . For example, it can be complexed by grinding at a high speed of 20000-30000 r/min for 50 to 60 seconds.

The grinding aid can adopt any suitable grinding aid. More preferably, the grinding aid is selected one or several from sodium chloride, sodium citrate, sodium carbonate and sodium phosphate.

The person skilled in the art can add suitable amounts of PVP-K30, the iodine and the grinding aid according to the experience. Preferably, the PVP-K30 is 46-47 g, the iodine is 7 g, and the grinding aid is 0.19-0.27 g.

The high-stable non-ionic N-vinyl butyrolactam iodine can be any high-stable non-ionic N-vinyl butyrolactam iodine meeting a condition that the degradation rate after the high-stable non-ionic N-vinyl butyrolactam iodine is positioned at 85° C. for 15 hours is less than 6.0%. Preferably, the high-stable non-ionic N-vinyl butyrolactam iodine is YuKing®-PVPI (H) prepared by Shanghai Yu King New Material Technology Development Co., Ltd.,

In a second aspect of the present invention, a high-stable non-ionic N-vinyl butyrolactam iodine solution is provided and characterized in that, the high-stable non-ionic N-vinyl butyrolactam iodine solution is obtained by the preparation method of a high-stable non-ionic N-vinyl butyrolactam iodine solution mentioned above.

The beneficial effects of the present invention are as follows:

1. The present invention prepares the high-stable non-ionic N-vinyl butyrolactam iodine solution by dissolving high-stable non-ionic N-vinyl butyrolactam iodine in water, adding citric acid, at least one iodine ion stabilizing agent, at least one non-ionic surfactant and at least one emulsifier, adjusting the pH to 5 with at least one pH adjusting agent, and the stability of the high-stable non-ionic N-vinyl butyrolactam iodine solution prepared is high, thereby facilitating long-term storage and use, thus the high-stable non-ionic N-vinyl butyrolactam iodine solution is suitable for large-scale popularization.

2. The present invention does not use the conventional PVPI, instead use the high-stable non-ionic N-vinyl butyrolactam iodine formed by complexing PVP-K30, iodine and at least one grinding aid at a temperature of 60° C.-90° C., such as the YuKing®-PVPI (H) product prepared by Shanghai Yu King New Material Technology Development Co., Ltd., compared with the conventional PVPI, the stability is high, so as to contribute to the stability of the high-stable non-ionic N-vinyl butyrolactam iodine solution prepared.

### DETAILED DESCRIPTION OF THE PREFERRED EMBODIMENT

In order to understand the technical content of the present invention clearly, the present invention is further exemplified by reference to the following examples. The raw materials and equipments involved in the examples are as follows:

Experimental materials: ordinary PVPI (YuKing®-PVPI (C), Shanghai Yu King New Material Technology Development Co., Ltd., prepared by complexing 6.5 g iodine and 43.5 g PVP-K30 at 60° C. for 2 hours), high-stable PVPI (YuKing®-PVPI (H), Shanghai Yu King New Material Technology Development Co., Ltd.,), potassium iodate (AR), Tween-20 (CP), polyethylene glycol 200 (CP), citric acid (AR), sodium hydroxide (AR). The above mentioned reagents are commercially available.

### Instruments and Equipments

| Instrument name | Model | Place of origin |
|---|---|---|
| Air blowing | DZF-6021 | Shanghai Suopu Instrument Co., Ltd. |
| thermostatic | | |
| drying oven | | |
| Electronic | FA2004 | Shanghai Liangping Instrument Co., Ltd. |
| analytical balance | | |
| Alkali burette | 50 ml | Shanghai Heqi Glass Instrument Co., Ltd. |

### Embodiment 1

20 g ordinary PVPI prepared by Shanghai Yu King New Material Technology Development Co., Ltd. is dissolved by adding appropriate water, the pH is adjusted to 5 with 0.2 mol/L sodium hydroxide solution and the PVPI solution is diluted with water to 200 ml.

### Embodiment 2

20 g high-stable PVPI prepared by Shanghai Yu King New Material Technology Development Co., Ltd. is dissolved by adding appropriate water, the pH is adjusted to 5 with 0.2 mol/L sodium hydroxide solution and the PVPI solution is diluted with water to 200 ml.

### Embodiment 3

20 g ordinary PVPI prepared by Shanghai Yu King New Material Technology Development Co., Ltd. is dissolved by adding appropriate water, in addition 0.5 g potassium iodate, 0.5 g Tween-20, 2.5 g polyethylene glycol 200 and 2.5 g citric acid are dissolved in purified water and added into the PVPI solution, the pH is adjusted to 5 with 0.2 mol/L sodium hydroxide solution and the PVPI solution is diluted with water to 200 ml and ready for use.

### Embodiment 4

20 g high stable PVPI prepared by Shanghai Yu King New Material Technology Development Co., Ltd. is dissolved by adding appropriate water, in addition 0.5 g potassium iodate, 0.5 g Tween-20, 2.5 g polyethylene glycol 200 and 2.5 g citric acid are dissolved in purified water and added in the PVPI solution, the pH is adjusted to 5 with 0.2 mol/L sodium hydroxide solution and the PVPI solution is diluted with water to 200 ml and ready for use.

### Embodiment 5

20 g high-stable PVPI prepared by Shanghai Yu King New Material Technology Development Co., Ltd. is dissolved by adding appropriate water, in addition 1.0 g potassium iodate, 0.1 g Tween-20, 0.5 g polyethylene glycol 200 and 5.0 g citric acid are dissolved in purified water and added into the PVPI solution, the pH is adjusted to 5 with 0.2 mol/L sodium hydroxide solution and the PVPI solution is diluted with water to 200 ml and ready for use.

### Embodiment 6

20 g high-stable PVPI prepared by Shanghai Yu King New Material Technology Development Co., Ltd. is dissolved by adding appropriate water, in addition 0.1 g potassium iodate, 1.0 g Tween-20, 5.0 g polyethylene glycol 200 and 0.5 g citric acid are dissolved in purified water and added into the PVPI solution, the pH is adjusted to 5 with 0.2 mol/L sodium hydroxide solution and the PVPI solution is diluted with water to 200 ml and ready for use.

### Embodiment 7

### Stability Test

The PVPI solutions prepared in Embodiments 1-6 mentioned above are sealed in a plastic bottle respectively, and placed in the air blowing thermostatic drying oven to be accelerated at 85° C. for 15 h, then measured the available iodine content according to the USP method: 2 copies of 20 ml of a sample solution are pipetted accurately and transferred into an iodine flask respectively, and each is titrated with 0.01 mol/L sodium thiosulfate standard solution till the color is light yellow, 2 ml starch indicator is added, and the titration continues till the blue color disappears, the volume of the sodium thiosulfate titration solution used is recorded and the available iodine content of the solution is calculated, and the results are as follows:

TABLE 1
the available iodine contents and the stabilities of PVPI
solutions with pH 5 stored at 85° C. for 15 h

| | | available iodine | changed value of |
|---|---|---|---|
| | Initial available | content | available |
| Number | iodine content (%) | (%) after 15 h | iodine (%) |
| Embodiment 1 | 1.02 | 0.78 | −23.35 |
| Embodiment 2 | 1.02 | 0.97 | −4.35 |
| Embodiment 3 | 1.01 | 0.97 | −3.26 |
| Embodiment 4 | 1.03 | 1.01 | −1.57 |
| Embodiment 5 | 1.03 | 1.01 | −1.95 |
| Embodiment 6 | 1.02 | 1.00 | −1.75 |

Note:
The available iodine content is calculated based on the solution.

For different storage conditions and different pH values have relatively great effects on the stability of the povidone-iodine (PVPI) solution, this experiment adopts the same storage container and the same pH value to investigate the stabilities of two groups of one solution. The results show that only adjusting the pH to 5 with sodium hydroxide is not ideal to the maintainment of the stability of the povidone-iodine solution, but when potassium iodate, Tween-20, polyethylene glycol 200, and citric acid are added, the drop of the concentration of the available iodine of the povidone-iodine solution is controlled effectively. The reasons are that: Potassium iodate is an iodine ion inhibitor, when the PVPI reacts reversely, the increasement of the iodine ions can inhibit this reaction, thereby to ensure the stability of the solution; sodium hydroxide is a pH adjusting agent, PVPI itself has a relatively strong acidity, the solution is rather unstable, but when the pH is adjusted to 5 with sodium hydroxide, the stability of the solution can be maintained relatively good.

Therefore, there are two key factors to the preparation of the high stable PVPI solution: first is to require PVPI powders with good stability; second is to add corresponding additives, the iodine ion stabilizing agent such as potassium iodate, the non-ionic surfactant such as Tween-20, the emulsifier such as polyethylene glycol 200, citric acid, and the pH adjusting agent such as sodium hydroxide during the preparation of the solution. The synergistic effect between the two factors can greatly improve the stability of the solution, which is critical to the long-term storage of the povidone-iodine disinfectant.

To sum up, the stability of the high-stable non-ionic N-vinyl butyrolactam iodine solution of the present invention is high, thereby facilitating long-term storage and use, thus the high-stable non-ionic N-vinyl butyrolactam iodine solution is suitable for large-scale popularization.

In the present specification, the present invention has been described according to the particular embodiments. But it is obvious that these embodiments can be modified or changed without departure from the spirit and scope of the present invention. Therefore, the specification described above is exemplary only and not intended to be limiting.

1. A preparation method of a high-stable non-ionic N-vinyl butyrolactam iodine solution, characterized in that, high-stable non-ionic N-vinyl butyrolactam iodine meeting a condition that the degradation rate after the high-stable non-ionic N-vinyl butyrolactam iodine is positioned at 85° C. for 15 hours is less than 6.0% is dissolved in water, then citric acid, at least one iodine ion stabilizing agent, at least one non-ionic surfactant and at least one emulsifier are added, then the pH is adjusted to 5 with at least one pH adjusting agent, so as to prepare the high-stable non-ionic N-vinyl butyrolactam iodine solution.

2. The preparation method of a high-stable non-ionic N-vinyl butyrolactam iodine solution according to claim 1, characterized in that, the iodine ion stabilizing agent is potassium iodate, the non-ionic surfactant is Tween® 20, the emulsifier is polyethylene glycol 200, and the pH adjusting agent is sodium hydroxide.

3. The preparation method of a high-stable non-ionic N-vinyl butyrolactam iodine solution according to claim 1, characterized in that, the high-stable non-ionic N-vinyl butyrolactam iodine is 20 g, the citric acid is 0.5-5.0 g, the iodine ion stabilizing agent is 0.1-1.0 g, the non-ionic surfactant is 0.1-1.0 g and the emulsifier is 0.5-5.0 g.

4. The preparation method of a high-stable non-ionic N-vinyl butyrolactam iodine solution according to claim 1, characterized in that, the high-stable non-ionic N-vinyl butyrolactam iodine is formed by complexing PVP-K30, iodine and at least one grinding aid at a temperature of 60° C.-90° C.

5. The preparation method of a high-stable non-ionic N-vinyl butyrolactam iodine solution according to claim 4, characterized in that, the grinding aid is selected one or several from sodium chloride, sodium citrate, sodium carbonate and sodium phosphate.

6. The preparation method of a high-stable non-ionic N-vinyl butyrolactam iodine solution according to claim 4, characterized in that, the PVP-K30 is 46-47 g, the iodine is 7 g, and the grinding aid is 0.19-0.27 g.

7. The preparation method of a high-stable non-ionic N-vinyl butyrolactam iodine solution according to claim 1, characterized in that, the high-stable non-ionic N-vinyl butyrolactam iodine is YuKing®-PVPI (H).

8. A high-stable non-ionic N-vinyl butyrolactam iodine solution, characterized in that, the high-stable non-ionic N-vinyl butyrolactam iodine solution is obtained by the preparation method of a high-stable non-ionic N-vinyl butyrolactam iodine solution according claim 1.
